(19) United States
(12) Patent Application Publication
(10) Pub. No.: US 2020/0163367 A1
(43) Pub. Date: May 28, 2020

(54) PROCESSED MEAT PRODUCT COMPRISING A CELLULOSE ETHER AND A FIBER-CONTAINING PECTIN PRODUCT

(71) Applicant: Dow Global Technologies LLC, Midland, MI (US)

(72) Inventors: Puspendu Deo, Pearland, TX (US); Britta Huebner-Keese, Uetze (DE)

(21) Appl. No.: 16/067,406

(22) PCT Filed: Mar. 28, 2017
(86) PCT No.: PCT/US2017/024469

§ 371 Date: Jun. 29, 2018

Related U.S. Application Data
(60) Provisional application No. 62/315,042, filed on Mar. 30, 2016.

(51) Int. Cl. A23L 13/40; A23L 29/262; A23L 13/60; A23L 29/231

(52) U.S. Cl. CPC A23L 13/422; A23L 29/231; A23L 13/65; A23L 29/262

(57) ABSTRACT

Provided is a processed meat product which comprises (a) one or more cellulose ethers and (b) a fiber-containing pectin product or pectin, wherein the weight ratio between components (a) and (b) is from 0.1:1 to 10:1. The combination of (a) one or more cellulose ethers and (b) a fiber-containing pectin product or pectin, wherein the weight ratio between (a) and (b) is from 0.1:1 to 10:1, is useful for improving one or more properties of a processed meat product selected from water binding capacity, cohesion, firmness, juiciness, bite, freeze thaw stability or texture; resistance to shrinking during cooking, or boil-out control.

### FIELD

This invention relates to a processed meat product that comprises a cellulose ether and a fiber-containing pectin product or pectin.

### INTRODUCTION

The use of cellulose ethers, such as methylcelluloses, hydroxypropyl methylcelluloses or carboxymethyl celluloses, in food products has been known for a long time. U.S. Pat. No. 6,235,893 discloses methylcellulose of enhanced gel strength and its use in a large variety of products including meat patties or reformed sea food. International Patent Application WO 2012/173838 discloses hydroxypropyl methylcelluloses that provide good hardness and/or cohesion to solid food compositions. WO 2012/173838 also discloses the use of these hydroxypropyl methylcelluloses in a large variety of products including meat patties or reformed sea food.

Increasing the amount of methylcellulose (MC) or hydroxypropyl methylcellulose (HPMC) in processed meat products typically increases its binding capacity and its ability to maintain the shape of the processed meat products. However, it is desired to provide increased structural stability or cohesion to a processed meat product at a given concentration of MC or HPMC. Alternatively, it is desired to provide good structural stability or cohesion to processed meat products at a relatively low concentration of the MC or HPMC. One reason for these desires is that MC or HPMC is usually more expensive than other typical ingredients. Another reason for desiring to reduce the amount of MC or HPMC is that some consumers find that when large amounts of MC or HPMC are used in processed meat products, the result can be an undesirable feeling in the mouth.

Surprisingly, it has been found that the binding capacity of MC or HPMC and/or their ability to maintain the shape of processed meat products can be increased by combining MC or HPMC with pectin or a fiber-containing pectin product at a certain weight ratio.

### SUMMARY

Accordingly, one aspect of the present invention is a processed meat product which comprises (a) one or more cellulose ethers and (b) a fiber-containing pectin product or pectin, wherein the weight ratio between components (a) and (b) is from 0.1:1 to 10:1. Another aspect of the present invention is a method of improving one or more properties of a processed meat product selected from water binding capacity, cohesion, firmness, bite, juiciness, freeze thaw stability or texture; resistance to shrinking during cooking, or boil-out control, which method comprises the step of incorporating into the meat product before or during processing (a) one or more cellulose ethers and (b) a fiber-containing pectin product or pectin, wherein the weight ratio between (a) and (b) is from 0.1:1 to 10:1.

### DESCRIPTION OF EMBODIMENTS

The term “processed meat” as used herein means any meat which has been modified in order either to improve its taste or extend its shelf life. Methods of meat processing are salting, curing, fermentation, boiling, smoking or other processes. Processed meat products include, for example, bacon, ham, hotdogs, sausages, cold cuts (Aufschnitt), salami, corned beef, beef jerky, canned meat and meat-based sauces.

Component (a) of the processed meat product of the present invention is one or more cellulose ethers. Preferred cellulose ethers are carboxy-C₁-C₃-alkyl celluloses, such as carboxymethyl celluloses; carboxy-C₁-C₃-alkyl hydroxy-C₁-C₃-alkyl celluloses, such as carboxymethyl hydroxyethyl celluloses; C₁-C₃-alkyl celluloses, such as methylcelluloses; C₁-C₃-alkyl hydroxy-C₁₋₃-alkyl celluloses, such as hydroxyethyl methylcelluloses, hydroxypropyl methylcelluloses or ethyl hydroxyethyl celluloses; hydroxy-C₁₋₃-alkyl celluloses, such as hydroxyethyl celluloses or hydroxypropyl celluloses; or mixed hydroxy-C₁-C₃-alkyl celluloses, such as hydroxyethyl hydroxypropyl celluloses. Particularly preferred cellulose ethers are methylcellulose, hydroxypropyl methylcellulose, hydroxyethyl methylcellulose, ethylhydroxy ethylcellulose, hydroxypropyl cellulose, sodium carboxymethyl cellulose or a combination of two or more of these cellulose ethers.

Methylcellulose (MC) is preferred as component (a). Methylcellulose has anhydroglucose units joined by 1-4 linkages. Each anhydroglucose unit contains hydroxyl groups at the 2, 3, and 6 positions. Partial or complete substitution of these hydroxyls with methoxyl groups creates methyl cellulose. For example, treatment of cellulosic fibers with caustic solution, followed by a methylating agent, yields cellulose ethers substituted with one or more methoxyl groups. If not further substituted with other alkyls, this cellulose ether is known as methylcellulose. Methylcellulose is characterized by the weight percent of methoxyl groups. By convention, the weight percent is an average weight percentage based on the total weight of the cellulose repeat unit, including all substituents. The content of the methoxyl group is reported based on the mass of the methoxyl group (i.e., —OCH₃). The determination of the % methoxyl in methylcellulose (MC) polymer is carried out according to the United States Pharmacopeia (USP 37, “Methylcellulose”, pages 3776-3778). The % methoxyl can be converted into degree of substitution (DS) for methyl substituents, DS(methyl). DS(methyl), also designated as DS(methoxyl), of a methylcellulose is the average number of OH groups substituted with methyl groups per anhydroglucose unit. Preferably, methylcellulose has % methoxyl of 18% or more; more preferably 25% or more. Preferably, ingredient (b) has % methoxyl of 50% or less; more preferably 40% or less; more preferably 35% or less. Even more preferably, methylcellulose has a DS(methyl) of 1.55 or higher; more preferably 1.65 or higher; and most preferably 1.70 or higher. DS(methyl) is preferably 2.25 or lower; more preferably 2.20 or lower; and most preferably 2.10 or lower.

Unless otherwise mentioned, methylcellulose is also characterized by the viscosity of a 2 wt.-% solution in water at 20° C. The 2 wt.-% methylcellulose solution in water can be prepared and tested according to United States Pharmacopeia (USP 37, “Methylcellulose”, pages 3776-3778). As described in the United States Pharmacopeia, viscosities of 600 mPa·s or more can be determined using a Brookfield viscometer. Preferably, methylcellulose has a viscosity of 10,000 mPa·s or more; more preferably 20,000 mPa·s or more; and most preferably 30,000 mPa·s or more. Preferably, methylcellulose has a viscosity of 150,000 mPa·s or less; more preferably 100,000 mPa·s or less, and most preferably 80,000 mPa·s or less. All these viscosities are as a 2 wt.-% solution in water at 20° C.

Another useful characterization of methylcellulose is the quotient s23/s26. The numerals 2, 3, and 6 refer to the carbon atoms on the anyhdroglucose units, defined as in structure I:

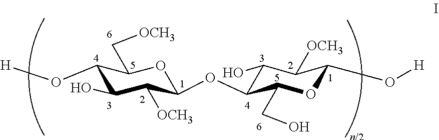

The parameter s23 is the molar fraction of anhydroglucose units wherein only the two hydroxy groups in the 2- and 3-positions of the anhydroglucose unit are substituted with methyl groups, and the parameter s26 is the molar fraction of anhydroglucose units wherein only the two hydroxy groups in the 2- and 6-positions of the anhydroglucose unit are substituted with methyl groups. For determining the s23, the term “the molar fraction of anhydroglucose units wherein only the two hydroxy groups in the 2- and 3-positions of the anhydroglucose unit are substituted with methyl groups” means that the two hydroxy groups in the 2- and 3-positions are substituted with methyl groups and the 6-positions are unsubstituted hydroxy groups. For determining the s26, the term “the molar fraction of anhydroglucose units wherein only the two hydroxy groups in the 2- and 6-positions of the anhydroglucose unit are substituted with methyl groups” means that the two hydroxy groups in the 2- and 6-positions are substituted with methyl groups and the 3-positions are unsubstituted hydroxy groups. The quotient s23/s26 is determined by dividing s23 by s26. Generally s23/s26 is 0.36 or less, preferably 0.34 or less, more preferably 0.32 or less, most preferably 0.30 or less, and particularly 0.28 or less. Moreover, s23/s26 is generally 0.10 or more, preferably 0.14 or more, more preferably 0.16 or more, most preferably 0.18 or more and particularly 0.20 or more. Methylcellulose having an above-described s23/s26 ratio and a method of preparing it are described in International Patent Application, publication No. WO 2013/059064.

The viscosities of the methylcelluloses that have a quotient s23/s26 of 0.25 or less are determined as a 2 wt.-% solution in water at 5° C. in view of their low gelation temperatures. The 2 wt.-% methylcellulose solution in water is prepared under stirring, cooling to a temperature of 2° C. for 5 hours and storing in a refrigerator at 5° C. over night. Preferably, these methylcelluloses have a viscosity of 20,000 mPa·s or more; more preferably 30,000 mPa·s or more; and most preferably 50,000 mPa·s or more. Preferably, these methylcelluloses have a viscosity of 200,000 mPa·s or less; more preferably 150,000 mPa·s or less, and most preferably 130,000 mPa·s or less, all viscosities measured as a 2 wt.-% solution in water at 5° C. The viscosities are determined using a Brookfield viscometer. The viscosities of the other methylcelluloses, i.e., those that do not have a quotient s23/s26 of 0.25 or less, are determined as a 2 wt.-% solution in water at 20° C., as described above.

Alternatively, hydroxypropyl methylcellulose (HPMC) is used as component (a). HPMC is characterized by the weight percent of methoxyl groups and of hydroxypropyl groups. The weight percentages are based on the total weight of the hydroxypropyl methylcellulose. By convention, the weight percent is an average weight percentage based on the total weight of the cellulose repeat unit, including all substituents. The content of the methoxyl group is reported based on the mass of the methoxyl group (i.e., —OCH₃). The content of the hydroxypropoxyl group is reported based on the mass of the hydroxypropoxyl group (i.e., —O—C₃H₆OH). The determination of the % methoxyl and the % hydroxypropoxyl in HPMC is carried out according to the United States Pharmacopeia (USP 37, “Hypromellose”, pages 3296-3298).

The % methoxyl in HPMC can be converted into degree of substitution (DS) for methyl substituents, DS(methyl). DS(methyl), also designated as DS(methoxyl), of a HPMC is the average number of OH groups substituted with methyl groups per anhydroglucose unit. For determining the DS(methyl), the term “OH groups substituted with methyl groups” does not only include the methylated OH groups at the polymer backbone, i.e., that are directly a part of the anhydroglucose unit, but also methylated OH groups that have been formed after hydroxypropoxylation. Preferably the HPMC has a DS(methyl) of 1.2 or higher; more preferably 1.4 or higher; and most preferably 1.65 or higher or even 1.75 or higher. DS(methyl) is preferably 2.2 or lower; more preferably 2.1 or lower; and most preferably 2.05 or 2.00 or lower.

The % hydroxypropoxyl in HPMC can be converted into MS(hydroxypropoxyl). The degree of the substitution of hydroxyl groups of the anhydroglucose units by hydroxypropoxyl groups is expressed by the molar substitution of hydroxypropoxyl groups, the MS(hydroxypropoxyl). The MS(hydroxypropoxyl) is the average number of moles of hydroxypropoxyl groups per anhydroglucose unit in the HPMC. It is to be understood that during the hydroxypropoxylation reaction the hydroxyl group of a hydroxypropoxyl group bound to the cellulose backbone can be further etherified by a methylation agent, and/or a hydroxypropylation agent. Multiple subsequent hydroxypropylation etherification reactions with respect to the same carbon atom position of an anhydroglucose unit yields a side chain, wherein multiple hydroxypropoxyl groups are covalently bound to each other by ether bonds, each side chain as a whole forming a hydroxypropoxyl substituent to the cellulose backbone. The term “hydroxypropoxyl groups” thus has to be interpreted in the context of the MS(hydroxypropoxyl) as referring to the hydroxypropoxyl groups as the constituting units of hydroxypropoxyl substituents, which either comprise a single hydroxyalkoxyl group or a side chain as outlined above, wherein two or more hydroxypropoxyl units are covalently bound to each other by ether bonding. Within this definition it is not important whether the terminal hydroxyl group of a hydroxypropoxyl substituent is further methylated or not; both methylated and non-methylated hydroxypropoxyl substituents are included for the determination of MS(hydroxypropoxyl). Generally the HPMC has an MS(hydroxypropoxyl) of 0.11 or more, preferably of 0.13 or more, more preferably of 0.15 or more, and most preferably of 0.18 or more. Generally the HPMC has an MS(hydroxypropoxyl) of 1.00 or less, preferably of 0.80 or less, more preferably of 0.70 or less and most preferably of 0.60 or 0.50 or less.

Hydroxypropyl methylcellulose is also characterized by the viscosity of a 2 wt. % solution in water at 20° C. The 2% by weight hydroxypropyl methylcellulose solution in water is prepared and tested according to United States Pharmacopeia (USP 37, “Hypromellose”, pages 3296-3298). As described in the United States Pharmacopeia, viscosities of 600 mPa·s or more can be determined using a Brookfield viscometer. Preferably, hydroxypropyl methylcellulose has a viscosity of 10,000 mPa·s or more; more preferably 20,000 mPa·s or more; and most preferably 30,000 mPa·s or more as a 2 wt.-% solution in water at 20° C. Preferably, hydroxypropyl methylcellulose has a viscosity of 150,000 mPa·s or less; more preferably 100,000 mPa·s or less, and most preferably 80,000 mPa·s or less.

Preferably the hydroxypropyl methylcellulose (HPMC) has a unique distribution of methyl groups on the anhydroglucose units such that s23/s26−0.2*MS(hydroxyalkyl) is 0.35 or less, preferably 0.32 or less, more preferably 0.30 or less, most preferably 0.27 or less, particularly 0.25 or less, and especially 0.23 or less. Typically [s23/s26-0.2*MS(hydroxyalkyl)] is 0.07 or more, more typically 0.10 or more, and most typically 0.13 or more. As used herein, the symbol “*” represents the multiplication operator. The numerals 2, 3, and 6 refer to the carbon atoms on the anyhdroglucose units, defined as in structure I further above. In the ratio s23/s26, s23 is the molar fraction of anhydroglucose units wherein only the two hydroxy groups in the 2- and 3-positions of the anhydroglucose unit are substituted with methyl groups and s26 is the molar fraction of anhydroglucose units wherein only the two hydroxy groups in the 2- and 6-positions of the anhydroglucose unit are substituted with methyl groups. For determining the s23, the term “the molar fraction of anhydroglucose units wherein only the two hydroxy groups in the 2- and 3-positions of the anhydroglucose unit are substituted with methyl groups” means that the 6-positions are not substituted with methyl; for example, they can be unsubstituted hydroxy groups or they can be substituted with hydroxypropyl groups or methylated hydroxypropyl groups. For determining the s26, the term “the molar fraction of anhydroglucose units wherein only the two hydroxy groups in the 2- and 6-positions of the anhydroglucose unit are substituted with methyl groups” means that the 3-positions are not substituted with methyl; for example, they can be unsubstituted hydroxy groups or they can be substituted with hydroxypropyl groups or methylated hydroxypropyl groups. Hydroxypropyl methylcellulose having a distribution of methyl groups on the anhydroglucose units such that s23/s26−0.2*MS(hydroxyalkyl) is 0.35 or less and a method of preparing it are described in International Patent Application, publication Nos. WO2012/051034 and WO 2012/173838.

A cellulose ether or a mixture of two or more different cellulose ethers, is referred to herein as ingredient (a).

Component (b) of the processed meat product of the present invention is a fiber-containing pectin product or pectin. Pectin or a fiber-containing pectin product can be obtained from citrus peel or from apple pomace which is a waste product from the juice industry. One method of producing a fiber-containing pectin product or pectin is described in International Patent Application WO 2013/109721, wherein citrus peel is treated to obtain homogenized citrus peel, the homogenized citrus peel is washed with an organic solvent, followed by a desolventizing and drying step to recover the fiber-containing pectin product or pectin. Preferably a comminuting or pulverizing step is carried out after the drying step.

Preferably a fiber-containing pectin product is obtained according to the process described in U.S. Pat. No. 7,833,558, the teaching of which is incorporated herein by reference. U.S. Pat. No. 7,833,558 describes a method of providing a fiber-containing pectin product from a plant material which comprises the steps of (i) providing an in situ reaction system by swelling the plant material in an aqueous solution comprising at least one salt, (ii) subjecting pectin present in the swollen plant material from step (i) to a de-esterification treatment, and (iii) separating the de-esterified fiber-containing pectin product. The plant material is preferably a native pectin-containing plant materials including peels or pulp from citrus fruits, such as lemon, orange, mandarin, lime and grapefruit. Other suitable native pectin-containing plant materials include sugar beet slices, potato pulp and pomace residues from apples. The aqueous solution used for the swelling step (i) preferably does not contain an organic solvent. The aqueous solution, in which the pectin-containing plant starting material is swelled, may contain at least one added water-soluble and neutral salt, such as sodium salts, potassium salts and calcium salts, and mixtures thereof. Particularly preferred are chlorides. The amount of salt added to the aqueous solution, in which the pectin-containing plant starting material is suspended and swelled, is preferably selected so that it corresponds to a salt concentration of from 1 mmol to 30 mmol per gram of dry matter of pectin-containing plant material. In the de-esterification treatment step (ii) the pectin-containing plant material is preferably treated with an alkaline reagent having a pH ranging from 7-14, preferably from 9-13, such as from 10-12. Preferred alkaline reagents are calcium hydroxide and sodium hydroxide or, most preferably, ammonia. During the de-esterification with e g ammonia in the aqueous reaction mixture, there is a competition between the two nucleophiles (NH₃ and OH), for which reason the de-esterification with OH, i.e., substitution of OCH₃ in the methyl-esterified carboxyl groups in pectin by OH forming COOH, may be accompanied by amidation, in which OCH₃ is replaced by NH₂ forming carboxamide groups, which, under the de-esterifying conditions, may result in at least 20% and no more than 70%, typically from 25% to 50%, of the methyl-esterified carboxyl groups in pectin being transformed into carboxamide groups. The treated plant material (after being subjected to de-esterification and optionally amidation) may by separated from the e.g. alkaline reaction mixture and subjected to at least one washing step and/or at least one pressing step, optionally followed by a drying step and a comminution step, to obtain a fiber-containing pectin product. The separation of the treated plant material from the reaction mixture may be carried out by any appropriate method, such as draining, filtration or centrifugation. The separated plant material treated with alkaline reagent may be washed at least once by suspending the material in aqueous mineral acid, such as sulphuric acid, hydrochloric acid or nitric acid, so that the pH in the suspension is from 1-6. Subsequently the washed plant material is separated and may then be washed at least once with water by resuspending it, e.g. in demineralised water. The fiber-containing pectin product obtained may be dried to a dry matter content of at least 40% by weight, such as at least 70% by weight, or even at least 90% by weight. By this process fiber-containing pectin products are provided with a degree of esterification of from 2% to 40%, a degree of amidation of no more than 30%, and a dry matter content of at least 16% by weight. U.S. Pat. No. 7,833,558 discloses that the fiber-containing pectin products are able to form a stable gel or a viscous solution with calcium ions in an aqueous solution containing from 25 to 65% by weight, such as from 25 to 50% by weight of saccharose, the pH of the solution being in the range of 1-7, such as about 3. The fiber-containing pectin product is a product that comprises pectin and fibers, preferably citrus fibers. The pectin content can vary; it is generally from 10 to 85%, typically from 20 to 60%, and more typically from 35 to 45% by weight of pectin, based on the total dry weight of pectin and fibers. The remaining amount is typically fibers like cellulose or hemicellulose. Pectin is a linear polymer composed of units of a-D-galacturonic acid attached by a-1,4-glycoside bonds to form long chains of polygalacturonic acid. The galacturonic acid units are esterified with methanol to a varying degree. A distinction is thus made between high-ester pectin having a degree of esterification of greater than 50% and low-ester pectin having a degree of esterification of less than 50%. The degree of esterification is defined as the number of methyl-esterified galacturonic acid units expressed as a percentage of the total galacturonic acid units in the pectin molecule and may thus be a value between 0% and 100%. These two groups of pectin gel by different mechanisms. High-ester-pectin requires a minimum amount of soluble solids and a pH within a narrow range, around 3.0, in order to form gels. High-ester-pectin gels are thermally reversible. In general, high-ester-pectins are hot water soluble and often contain a dispersion agent such as dextrose to prevent lumping. Low-ester-pectins produce gels independent of sugar content. They also are not as sensitive to pH as the high-ester-pectins are. Low-ester-pectins require the presence of a controlled amount of calcium or other divalent cations for gelation. The chemical properties of pectin are described in more detail in Gum Technology in food industry: Chapter 6, Pectins, Industrial Gums: Polysaccharides and their derivatives: Chapter 10, Chemistry of Pectin and Its Pharmaceutical Uses: A Review, pages 208-228 by Pornsak Sriamornsak. Pectin is preferably a pectin product obtainable according to the process described in U.S. Pat. No. 7,833,558, the teaching of which is incorporated herein by reference. U.S. Pat. No. 7,833,558 describes a method for providing a pectin product comprising the steps of: i) providing a fiber-containing pectin product according to the process described further above, ii) adding an extraction medium to the fiber-containing pectin product providing an aqueous extraction suspension, (iii) adjusting the pH of the extraction suspension to a pH in the range of 1-12, such as in the range of 1-7, e.g. by addition of a strong acid or a base, (iv) adjusting the temperature of the extraction suspension to a temperature in the range of 0-120° C., such as in the range of 60-80° C., and (v) isolating the pectin product from the aqueous phase of the extracting medium.

The combination of (a) one or more cellulose ethers and (b) a fiber-containing pectin product or pectin, is useful for improving one or more properties of a processed meat product selected from water binding capacity, cohesion, firmness, bite, juiciness, freeze thaw stability or texture; resistance to shrinking during cooking, or boil-out control. The combination of the components (a) and (b) is particularly useful for improving the cohesion and/or firmness of a processed meat product. Surprisingly, it has been found that the combination of the components (a) and (b) is much more effective than the components (a) or (b) individually.

The weight ratio between components (a) and (b) in the processed meat product of the present invention is at least 0.1:1, preferably at least 0.3:1, more preferably at least 0.5:1, even more preferably at least 0.75:1, and most preferably at least 0.9:1. The weight ratio between components (a) and (b) in the processed meat product of the present invention is up to 10:1, preferably up to 3:1, more preferably up to 2:1, even more preferably up to 1.3:1, and most preferably up to 1.1:1. Preferred as component (a) is methylcellulose, more preferred a methylcellulose having the quotient s23/s26 as described further above. Preferred as component (b) is a fiber-containing pectin product.

Preferably the amount of component (a) is, by weight based on the weight of the processed meat product, 0.1% or more; more preferably 0.2% or more, even more preferably 0.3% or more, and most preferably 0.4% or more. Preferably the amount of component (a) is, by weight based on the weight of the processed meat product, 3.0% or less, preferably 2.0% or less; even more preferably 1.2% or less; and most preferably 0.9% or less.

Preferably the amount of component (b) is, by weight based on the weight of the processed meat product, 0.1% or more; more preferably 0.2% or more, even more preferably 0.3% or more, and most preferably 0.4% or more. Preferably the amount of component (a) is, by weight based on the weight of the processed meat product, 3.0% or less, preferably 2.0% or less; even more preferably 1.2% or less; and most preferably 1.0% or less.

Preferably, the processed meat product of the present invention comprises water. Preferably, the amount of water, by weight based on the processed meat product, is 20% or more; more preferably 30% or more; even more preferably 40% or more; and most preferably 50% or more. Preferably, the amount of water, by weight based on the processed meat product, is 80% or less; more preferably 70% or less.

Preferably, the processed meat product of the present invention comprises one or more animal fats or oils. Animal fats or oils are known; they are esters derived from glycerol and three fatty acids. Pork fat, chicken fat, and cow fat is preferred. Preferably, the amount of animal fat, by weight based on the processed meat product, is 5% or more; more preferably 10% or more; even more preferably 15% or more. Preferably, the amount of animal fat, by weight based on the processed meat product, is 40% or less; more preferably 30% or less, and more preferably 25% or less.

Preferably, the processed meat product of the present invention also comprises one or more dry ingredients selected from one or more proteins, sodium chloride, sodium chloride with nitrite (=curing salt; Nitritpokelsalz), sodium phosphates, sodium ascorbates, caseinates, citrates, sodium carbonates, one or more sugars, flavoring agents, starches, gluten, spices/seasonings and mixtures thereof.

Preferably, the processed meat product of the present invention comprises one or more meat proteins. Proteins are molecules that contain chains of amino acid residues. Proteins contain 30 or more residues of amino acids. Preferably the amount of proteins, by weight based on the weight of the processed meat product, is 2% or more; more preferably 4% or more; and most preferably 5% or more. Preferably the amount of proteins, by weight based on the weight of the processed meat product, is 30% or less; more preferably 25% or less; and most preferably 20% or less.

Preferably, the processed meat product of the present invention contains one or more sugars. As used herein, the term “sugar” refers to monosaccharides and disaccharides. Preferred sugars are sucrose, fructose, glucose (also known as dextrose), and mixtures thereof. Preferably the amount of sugar is, by weight based on the weight of the processed meat product, 0.1% or more; more preferably 0.2% or more; and most preferably 0.3% or more. Preferably the amount of sugar is, by weight based on the weight of the processed meat product, 5% or less; more preferably 3% or less; and most preferably 1% or less.

Preferably, the processed meat product of the present invention contains sodium chloride or sodium chloride with nitrite (curing salt). Preferably, the amount of sodium chloride is, by weight based on the weight of the processed meat product, 0.1% or more; and more preferably 0.2% or more. Preferably, the amount of sodium chloride is, by weight based on the weight of the processed meat product, 5% or less; more preferably 2% or less.

Components (a) and (b) of the composition of the present invention, i.e., (a) one or more cellulose ethers and (b) a fiber-containing pectin product or pectin, are incorporated into processed meat products, such as emulsified meat products, chopped meat products, pet food or ham. Examples of processed meat products include bacon, ham, hotdogs, cold cuts, sausages, salami, corned beef, beef jerky, canned meat and meat-based sauces. Emulsified meat products likes sausages are preferred. The processed meat product preferably comprises beef, veal, pork, lamb, fish or poultry.

Components (a) and (b) are incorporated into the meat product before or during its processing. The term “processing” as used herein means any individual step or a combination of steps that is or are applied in the production of processed meat products, such as mixing and/or chopping the components of the meat product to be prepared, heat treatment or freezing, or bringing the processed meat products into the desired shape. The combination of components (a) and (b) is able to form a strong gel in the processed meat product. Hence, an increased structural stability or cohesion of the processed meat is achieved. Alternatively, the use of components (a) and (b) in the processed meat product allows a higher water content in the processed meat product while still obtaining a similar consistency and texture as compared to a processed meat product that has a lower amount of water and that does not comprise components (a) and (b).

Processes for preparing processed meat products are known in the art. For example, in a process for preparing liverwurst, the fat/water/liver emulsion typically is heated/cooked during the cutter procedure. Sausages are prepared in a process where crushed ice/water, fat, meat, sodium chloride or sodium chloride with nitrite, additives such as caseinate, citrate, carbonate, phosphate or a mixture thereof, spices/seasonings and optionally coloring agents are mixed and processed. Chopped meat products (e.g. hamburgers) are prepared by finely grinding meat in a meat mincer, adding spices, salt, and water, and forming the meat product to a desired shape using a mould. In the processed meat products industry, two different procedures are used for preparing boiled and smoked hams, i.e. the injection of whole meat parts or coarse meat chunks followed by a tumbling process and a tumbling process of coarse meat chunks followed by pressing into natural or artificial casings. Components (a) and (b) can be mixed in a known manner with the other ingredients of the processed meat products before or during one or more processing steps.

Components (a) and (b) in combination provide excellent stability of the processed meat product during and after cooking. The achieved stability is much higher than achieved with components (a) or (b) individually. A of component (a) can be replaced by component (b) while still providing a high stability to processed meat products during and after cooking. This is very surprising because component (b) alone provides no or insufficient stability to processed meat products during and after cooking, as shown in the Examples. Partial replacement of the highly efficient but expensive component (a) is desirable.

### EXAMPLES

Some embodiments of the invention will now be described in detail in the following Examples. Unless otherwise mentioned, all parts and percentages are by weight.

Gelation Properties of Fiber-Containing Pectin Product Alone

Aqueous solutions and dispersions of a fiber-containing pectin product having the concentrations listed in Table 1 below were made as follows. The concentrations are by weight, based on the total weight of the aqueous solutions or dispersions.

Fiber-containing pectin product in the form of a powder was used as received without any drying before sample preparation. Fiber-containing pectin product was acquired from Florida Food Products, USA under the trademark FiberGel LC. FiberGel LC is obtained according to the procedure described in U.S. Pat. No. 7,833,558.

A pre-weighed amount of water was introduced into a clean glass vial. The water temperature in the vial was adjusted to about 20° C. with stirring using an overhead mixer. A pre-weighed amount (based on sample composition) of fiber-containing pectin product was then introduced with stirring into the water. The resulting solution or dispersion was stirred for 15 minutes. Subsequently the vial was capped and stored at room temperature for 48 hours before any rheological observations.

As indicated above, the fiber-containing pectin product utilized in the present examples is obtained according to the procedure described in U.S. Pat. No. 7,833,558. U.S. Pat. No. 7,833,558 discloses that the fiber-containing pectin product is able to form a stable gel or a viscous solution with calcium ions in an aqueous solution containing from 25 to 65% by weight of saccharose, the pH of the solution being in the range of 1-7, such as about 3. Therefore, the fiber-containing pectin product is useful as gelling agent in food products like jam or marmalades. However, processed meat products generally do not comprise such amounts of saccharose and/or do not have the required pH.

To evaluate the gelation properties of the fiber-containing pectin product utilized in the present invention, varying concentrations of fiber-containing pectin product were mixed with water and varying concentrations of calcium chloride. The mixtures were visually inspected. The results are listed in Table 1 below.

The results in Table 1 below illustrate that the fiber-containing pectin product utilized in the Examples of the present invention only forms a gel when mixed with water in the presence of calcium ions. The results show that an aqueous composition comprising fiber-containing pectin product alone does not form a gel in the absence of calcium ions. Moreover, many processed meat products like most sausages only contain up to 0.05 wt.-% of calcium ions, which is not sufficient to enable significant gelation of the fiber-containing pectin product at concentrations of about 1% or less, based on the total weight of the processed meat product.

TABLE 1

| | % fiber-containing pectin product | | | | | | | | | | | |
|---|---|---|---|---|---|---|---|---|---|---|---|---|
| % CaCl₂ | 0.0 | 0.25 | 0.5 | 0.75 | 1.0 | 1.25 | 1.5 | 1.75 | 2.0 | 2.25 | 2.5 | 3.0 |
| 0.0 | No* | No* | No* | No* | No* | No* | No* | No* | No* | No* | No* | No* |

| | | |
|---|---|---|
| 0.1 | onset gelation visible | Gel formation is increasingly visible |
| 0.25 | | |

| | | | |
|---|---|---|---|
| 0.5 | slight gel | visible gel formation | Clearly shaped gels |
| 0.75 | formation | | |
| 1.0 | | | |
| 1.5 | | | |
| 2.0 | | | |

*No gelation at 0.0% CaCl₂ concentration, independent of concentration of fiber-containing pectin product

### Examples 1 and Comparative Examples A-C

Emulsions of water/crushed ice, pork fat (chopped 3 mm) and a cellulose ether as component (a) and/or a fiber-containing pectin product as component (b) were prepared within a Stephan Universal machine UM 5 with vacuum unit and a double jacket under vacuum. The amount of pork fat was 20 wt.-%. The amounts of FiberGel LC and/or Methocel™ MX were as listed in Table 2 below. All percentages are based on the total weight of the emulsion. The remainder of the emulsions was water/crushed ice. The fat-containing aqueous emulsions are part of a processed meat product like sausages. The effectiveness of a cellulose ether as component (a), a fiber-containing pectin product as component (b) and the combination of components (a) and (b) in these emulsions is an indication of the effectiveness of components (a) and (b) separately and in combination in processed meat products.

The following components were also blended with the water/crushed ice and pork fat. Their amounts are listed in Table 2 below and are based on the total amount of the emulsion including all components.

Component (a): Methocel™ MX=methylcellulose from Dow Chemical Company having a methoxyl content of 27.5%-31.5%, a viscosity of about 50,000 MPa·s, measured as a 2 wt.-% solution in water at 20° C., and a ratio s23/s26 of 0.26-0.30, and

Component (b): FiberGel LC=fiber-containing pectin product from Florida Food Products. The fiber-containing pectin product is obtained according to the procedure described in U.S. Pat. No. 7,833,558.

The emulsion was heated up to 80° C. for 30 min., which is a similar process as for sausage preparation. The strength of the gelled emulsion was measured after cooling down to 45° C., to 20° C. and to 5° C. The measurement of the gel strength at 45° C., 20° C. and 5° C., respectively was measured as follows:

Cylindrically-shaped gels (height=25 mm, diameter=23 mm) were prepared by introducing the emulsion into a cylindrical container. Attention was paid to complete filling of the container. The container was closed at the top and put into a drying cabinet for 30 min at 80° C. in order to simulate the heating process of sausage preparation. Then the container was put into the heating cabinet (pre heated to 45° C. or 20° C.) of the texture analyzer. Gels were removed from the container and their temperature was adjusted in the heating cabinet to 45° C. or 20° C. prior to gel strength measurement. Some of the gels where put into a refrigerator for 30 minutes to adjust their temperature to 5° C. prior to gel strength measurement.

The gel strength was measured with a Texture Analyzer (model TA.XTPlus; Stable Micro Systems, 5 kg or 50 kg load cell) located inside a cabinet (model XT/TCH Stable Micro Systems, Surrey, UK) designed to hold the temperature at 45° C., 20° C. or 5° C., respectively. The cylindrically-shaped gels were compressed between two plates (50 mm diameter, test speed=0.5 mm/s, rear-speed=10 mm/s, trigger force=100 g (at 45° C.) or 10 g (at 20° C. or 5° C.), maximum distance=10 mm). The plate displacement [mm] and compression force [N] were measured at selected time intervals (400 points/s) until the gel collapsed. The maximum compressional force, measured prior to the gel collapse, was identified as gel strength. The results of six replicates were typically averaged and the average results reported in units of Newton. The results are listed in Table 2 below.

TABLE 2

| (Comp.) | A | B | C | 1 | 2 |
|---|---|---|---|---|---|
| Example | (wt. %) | (wt. %) | (wt. %) | (wt. %) | (wt. %) |
| Methocel ™ MX | 1.74 | 0 | 0 | 0.87 | 1.74 |
| FiberGel LC | 0 | 1.74 | 3.48 | 0.87 | 1.74 |

Strength of gelled emulsion

| | | | | | |
|---|---|---|---|---|---|
| At 45° C. | 17 N | — | — | 16 N | 45 N |
| At 20° C. | 5 N | — | — | 2 N | 15 N |
| At 5° C. | 3 N | — | — | 2 N | 10 N |

The results in Table 2 above illustrate the synergistic effect of methylcellulose and fiber-containing pectin product as gelling agents in fat-containing aqueous emulsions. High gel strength of fat-containing aqueous emulsions provides advantages in the production of sausages, cold cuts and other food products wherein fat-containing aqueous emulsions are used. A high gel strength increases the firmness, juiciness, bite and/or texture of the food product.

The comparison between Example 1 and Comparative Example A shows that a portion of the methylcellulose, such as Methocel™ MX, can be replaced by fiber-containing pectin product while still achieving comparable gel strength of the emulsion, particularly at warmer temperatures like 45° C. which is a temperature at which many processed meat products are eaten. The comparison between Example 2 and Comparative Example B shows that the gel strength of the emulsion can be increased by 2.5-3 times when incorporating fiber-containing pectin product in addition to methylcellulose in the fat-containing aqueous emulsion. These findings are surprising because the individual use of fiber-containing pectin product in the fat-containing aqueous emulsions did not provide a gel of any measurable strength, neither at a concentration of 1.74 wt. % nor at a concentration of 3.48 wt.-% (see Comparative Examples B and C).

1. A processed meat product comprising
(a) one or more cellulose ethers and
(b) a fiber-containing pectin product or pectin,
wherein the weight ratio between components (a) and (b) is from 0.1:1 to 10:1.

2. The processed meat product of claim 1 wherein the weight ratio between components (a) and (b) is from 0.3:1 to 3:1.

3. The processed meat product of claim 2 wherein the weight ratio between components (a) and (b) is from 0.5:1 to 2:1.

4. The processed meat product of claim 1 comprising from 0.1 to 3.0 weight percent of component (a) and from 0.1 to 3.0 weight percent of component (b), based on the total weight of the processed meat product.

5. The processed meat product of claim 4 comprising from 0.2 to 2.0 weight percent of component (a) and from 0.2 to 2.0 weight percent of component (b), based on the total weight of the processed meat product.

6. The processed meat product of claim 5 comprising from 0.3 to 1.2 weight percent of component (a) and from 0.3 to 1.2 weight percent of component (b), based on the total weight of the processed meat product.

7. The processed meat product of claim 1 wherein component (a) is a methylcellulose.

8. The processed meat product of claim 7 wherein the methylcellulose has anhydroglucose units joined by 1-4 linkages wherein hydroxy groups of anhydroglucose units are substituted with methyl groups such that s23/s26 is from 0.10 to 0.36,
wherein s23 is the molar fraction of anhydroglucose units wherein only the two hydroxy groups in the 2- and 3-positions of the anhydroglucose unit are substituted with methyl groups and
wherein s26 is the molar fraction of anhydroglucose units wherein only the two hydroxy groups in the 2- and 6-positions of the anhydroglucose unit are substituted with methyl groups.

9. The processed meat product of claim 8 wherein the methylcellulose has anhydroglucose units joined by 1-4 linkages wherein hydroxy groups of anhydroglucose units are substituted with methyl groups such that s23/s26 is from 0.14 to 0.34.

10. The processed meat product of claim 1 additionally comprising from 20 to 80 weight percent of water, based on the weight of the composition.

11. The processed meat product of claim 1 being an emulsified meat product, chopped meat product, pet food of ham.

12. The processed meat product of claim 11 being an emulsified meat product.

13. The processed meat product of claim 1 being a sausage.

14. A method of improving one or more properties of a processed meat product selected from water binding capacity, cohesion, firmness, juiciness, bite, freeze thaw stability or texture; resistance to shrinking during cooking, or boil-out control, which method comprises the step of incorporating into the meat product before or during processing (a) one or more cellulose ethers and (b) a fiber-containing pectin product or pectin, wherein the weight ratio between (a) and (b) is from 0.1:1 to 10:1.

15. The method of claim 14, wherein the method comprises the step of incorporating into the processed meat product from 0.2 to 2.0 weight percent of component (a) and from 0.2 to 2.0 weight percent of component (b), based on the total weight of the processed meat product, the weight ratio between (a) and (b) being from 0.3:1 to 3:1.
